(19) United States
(12) Patent Application Publication
(10) Pub. No.: US 2007/0155848 A1
(43) Pub. Date: Jul. 5, 2007

(54) Oxidation resistant carbon foam

(76) Inventors: Douglas J. Miller, North Olmsted, OH (US); Irwin C. Lewis, Strongsville, OH (US); Richard L. Shao, North Royalton, OH (US); Terrence A. Pirro, Cleveland, OH (US); Orest L. Andrianowycz, Broadview Heights, OH (US)

Correspondence Address: WADDEY & PATTERSON, P.C., 1600 DIVISION STREET, SUITE 500, NASHVILLE, TN, 37203, US

(21) Appl. No.: 11/322,080

(22) Filed: Dec. 29, 2005

(51) Int. Cl. C08G 63/00

(52) U.S. Cl. 521/180

(57) ABSTRACT

A carbon foam material with an improved oxidation resistance is created by blending formaldehyde with phenol to form a reactive mixture, polymerizing the reactive mixture with a non-oxidation promoting basic catalyst to form a resin article, foaming the resin article to create phenolic foam, and carbonizing the phenolic foam to create the carbon foam with an increased oxidation resistance. Specifically, the oxidation resistant carbon foam has a sodium content of approximately 0%. This inventive foam may also contain one or more oxidization inhibitors to impede the oxidation of the carbon foam when the foam is exposed to an oxidizing environment.

### BACKGROUND OF THE INVENTION

1. Technical Field

The present invention relates to oxidation resistant carbon foams useful for high temperature applications such as insulation materials. More particularly, the present invention relates to carbon foams exhibiting superior strength, weight and density characteristics while possessing improved resistance to oxidation. The invention also includes methods for the production of such foams.

2. Background Art

Carbon foams have attracted considerable recent activity because of their properties of low density, coupled with either very high or low thermal conductivity. Conventionally, carbon foams are prepared via two general routes. Highly graphitizable foams have been produced by thermal treatment of mesophase pitches under high pressure. These foams tend to have high thermal and electrical conductivities. For example, in Klett, U.S. Pat. No. 6,033,506, mesophase pitch is heated while subjected to a pressure of 1000 psi to produce an open-cell foam containing interconnected cells with a size range of 90-200 microns. According to Klett, after heat treatment to 2800° C., the solid portion of the foam develops into a highly crystalline graphitic structure with an interlayer spacing of 0.366 nm. The foam is asserted to have compressive strengths greater than previous foams (3.4 MPa or 500 psi for a density of 0.53 g/cm³).

In Hardcastle et al. U.S. Pat. No. 6,776,936, carbon foams with densities ranging from 0.68-1.5 g/cm³ are produced by heating a pitch in a mold at pressures up to 800 psi. The foam is alleged to be highly graphitizable and provide high thermal conductivity (250 W/m°K).

According to H. J. Anderson et al. in Proceedings of the 43rd International SAMPE Meeting, p. 756 (1998), carbon foam is produced from mesophase pitch followed by oxidative thermosetting and carbonization to 900° C. The foam has an open-cell structure of interconnected cells with varying shapes and with cell diameters ranging from 39 to greater than 480 microns.

Rogers et al., in Proceedings of the 45^{th} SAMPE Conference, p. 293 (2000), describe the preparation of carbon foams from coal-based precursors by heat treatment under high pressure to produce materials with densities of 0.35-0.45 g/cm³ and compressive strengths of 2000-3000 psi (thus a strength/density ratio of about 6000 psi/(g/cm³)). These foams have an open-cell structure of interconnected cells with cell sizes up to 1000 microns. Unlike the mesophase pitch foams described above, the coal-based foams are not highly graphitizable. In a recent publication, the properties of this type of foam are described (High Performance Composites, September 2004, p. 25). The foam has a compressive strength of 800 psi at a density of 0.27 g/cm³ or a strength-to-density ratio of 3000 psi/(g/cm³).

Stiller et al. (U.S. Pat. No. 5,888,469) describe production of carbon foam by pressure heat treatment of a hydrotreated coal extract. These materials are claimed to have high compressive strengths of 600 psi for densities of 0.2-0.4 g/cm³ (strength/density ratio of from 1500-3000 psi/(g/cm³)). It is suggested that these foams are stronger than those having a glassy carbon or vitreous nature that are not graphitizable.

Carbon foams can also be produced by direct carbonization of polymers or polymer precursor blends. Mitchell, in U.S. Pat. No. 3,302,999, discusses preparing carbon foams by heating a polyurethane foam at 200-255° C. in air followed by carbonization in an inert atmosphere at 900° C. These foams have densities of 0.085-0.387 g/cm³ and compressive strengths of 130 to 2040 psi (ratio of strength/density of 1529-5271 psi/(g/cm³)).

In U.S. Pat. No. 5,945,084, Droege describe the preparation of open-cell carbon foams by heat treating organic gels derived from hydroxylated benzenes and aldehydes (phenolic resin precursors). The foams have densities of 0.3-0.9 g/cm³ and are composed of small mesopores with a size range of 2 to 50 nm.

Mercuri et al. (Proceedings of the 9^{th} Carbon Conference, p. 206 (1969)) prepare carbon foams by pyrolysis of phenolic resins. For foams with a density range of 0.1-0.4 g/cm³, the compressive strength to density ratios are 2380-6611 psi/(g/cm³). The cells are ellipsoidal in shape with cell diameters of 25-75 microns for a carbon foam with a density of 0.25 g/cm³.

Stankiewicz (U.S. Pat. No. 6,103,149) prepares carbon foams with a controlled aspect ratio range of 0.6-1.2. The patentee points out that users often require a completely isotropic foam for superior properties with an aspect ratio of 1.0 being ideal. An open-cell carbon foam is produced by impregnation of a polyurethane foam with a carbonizable resin followed by thermal curing and carbonization. The cell aspect ratio of the original polyurethane foam is thus changed from 1.3-1.4 to 0.6-1.2.

Unfortunately, carbon foams produced by the prior art processes are not effective for many high temperature applications where oxidation resistance is crucial for the integrity of the carbon foam product. Generally, non-graphitizable carbon foam exhibits the most desirable strength, weight and strength to density ratio characteristics for high temperature applications, yet is more susceptible to oxidation than graphitizable foams. Often the polymerization catalyst used in forming the precursor resin, as well as additional reagents used in the foaming operation, promote oxidation of the carbon foam when the foam is exposed to air at elevated temperatures. Thus, these carbon foam structures are not as suitable for use in high temperature applications where air exposure cannot be prevented.

What is desired, therefore, is a carbon foam which is monolithic, has a controllable cell structure, and has an increased oxidation resistance, where the cell structure, strength and strength to density ratio make the foam suitable for use in high temperature applications. Moreover, a carbon foam is also desired in which the content of sodium or other oxidation catalyzing metals in the foam is approximately zero. The metal content in the foam can be determined using the inductively coupled plasma (ICP) technique as in ASTM D5600. Indeed, a combination of characteristics, including oxidation resistance and strength to density ratios higher than contemplated in the prior art, have been found to be necessary for use of a carbon foam in high temperature applications. Also desired is a process for preparing such foams.

### SUMMARY OF THE INVENTION

The present invention provides a carbon foam which is uniquely capable of use in high temperature applications, such as for thermal insulation. The inventive foam exhibits a resistance to oxidation and a compressive strength to density ratio which provide a combination of durability, resistance to breakdown or failure, strength and relatively light weight characteristics not heretofore seen. Optimally, oxidation promoting metals are eliminated from the inventive carbon foam, specifically with the content of sodium and other oxidation promoting metals in the foam approximating 0%. In addition, the monolithic nature and bimodal cell structure of the foam, with a combination of larger and smaller cells, which are relatively spherical and not highly interconnected, provide a carbon foam which can be produced in a desired size and configuration and which can be readily machined.

More particularly, the inventive carbon foam has a density of about 0.03 to about 0.6 gram per cubic centimeter (g/cm³), with a compressive strength of at least about 2000 pounds per square inch (psi) (measured by, for instance, the ASTM C695 method). An important characteristic for the foam when intended for use in a high temperature application is the ratio of strength to density. For such applications, a ratio of strength to density of at least about 7000 psi/(g/cm³) is required, more preferably at least about 8000 psi/(g/cm³).

The inventive carbon foam should have a relatively uniform distribution of cells in order to provide the required high compressive strength. The cells should not be highly interconnected and the foam should not have an open-cell structure. In addition, the cells should be relatively isotropic, by which is meant that the cells are relatively spherical, meaning that the cells have, on average, an aspect ratio of between about 1.0 (which represents a perfect spherical geometry) and about 1.5. The aspect ratio is determined by dividing the longer dimension of any cell with its shorter dimension.

The foam should have a total porosity of about 50% to about 95%, more preferably about 60% to about 95%. In addition, it has been found highly advantageous to have a bimodal cell size distribution, that is, a combination of two average cell sizes, with the primary fraction being the larger size cells and a minor fraction of smaller size cells. Preferably, of the cells, at least about 90% of the cell volume, more preferably at least about 95% of the cell volume should be the larger size fraction, and at least about 1% of the cell volume, more preferably from about 2% to about 10% of the cell volume, should be the smaller size fraction.

The larger cell fraction of the bimodal cell distribution in the inventive carbon foam should be about 10 to about 150 microns in diameter, more preferably about 15 to about 95 microns in diameter, most preferably about 25 to about 95 microns in diameter. The smaller fraction of cells should comprise cells that have a diameter of about 0.8 to about 3.5 microns, more preferably about 1 to about 2 microns. The bimodal cell-structure nature of the inventive foams provide an intermediate structure between open-cell foams and closed-cell foams, thus limiting the fluid permeability of the foam while maintaining a foam structure. Indeed, advantageously, the inventive carbon foams should exhibit a nitrogen gas permeability of no greater than about 3.0 darcys, more preferably no greater than about 2.0 darcys (as measured, for instance, by the ASTM C577 method).

Advantageously, to produce the inventive foams, a polymeric foam block, particularly a phenolic foam block, is carbonized in an inert or air-excluded atmosphere, at temperatures which can range from about 500° C., more preferably at least about 800° C., up to about 3200° C. to prepare carbon foams useful in high temperature applications.

An object of the invention, therefore, is a monolithic carbon foam having characteristics that enable it to be employed in high temperature applications such as in composite tooling applications.

Another object of the invention is a carbon foam having oxidation resistant characteristics which enables it to be employed in high temperature applications, such as for thermal insulation.

Yet another object of the invention is a carbon foam having the resistance to oxidation, density, compressive strength and ratio of compressive strength to density sufficient for high temperature and/or high pressure applications.

Still another object of the invention is a carbon foam having a porosity and cell structure and size distribution to provide utility in applications where highly connected porosity is undesirable.

Yet another object of the invention is a carbon foam which can be produced in a desired size and configuration, and which can be readily machined or joined to provide larger carbon foam structures.

Another object of the invention is to provide a method of producing the inventive carbon foam.

These aspects and others that will become apparent to the artisan upon review of the following description can be accomplished by providing a carbon foam article produced using a polymeric foam, such as a phenolic resol, formed by polymerization using a catalyst selected to reduce oxidation of the finished carbon foam. The precursor polymeric foam can also include solid oxidation inhibiting additives to decrease the rate of oxidation of the final carbon foam product. Moreover, the carbon foam can be treated with an oxidation-inhibiting agent after the final carbonization step for an additional protection against oxidation.

The inventive carbon foam has a ratio of compressive strength to density of at least about 7000 psi/(g/cm³), especially a ratio of compressive strength to density of at least about 8000 psi/(g/cm³). The inventive foam product advantageously has a density of from about 0.03 to about 0.6 g/cm³ and a compressive strength of at least about 2000 psi, and a porosity of between about 50% and about 95%. The cells of the carbon foam have, on average, an aspect ratio of between about 1.0 and about 1.5.

Preferably, at least about 90% of the cell volume is made of the cells having a diameter of between about 10 and about 150 microns; indeed, most preferably at least about 95% of the cell volume is made of the cells having a diameter of between about 25 and about 95 microns. Advantageously, at least about 1% of the cell volume is made of the cells having a diameter of between about 0.8 and about 3.5 microns, more preferably, from about 2% to about 10% of the cell volume is made of the cells having a diameter of about 1 to about 2 microns.

The inventive foam can be produced by carbonizing a polymeric foam article, especially a phenolic foam, in an inert or air-excluded atmosphere. The phenolic foam should preferably have a compressive strength of at least about 100 psi.

It is to be understood that both the foregoing general description and the following detailed description provide embodiments of the invention and are intended to provide an overview or framework of understanding to nature and character of the invention as it is claimed.

### DETAILED DESCRIPTION OF THE PREFERRED EMBODIMENTS

Carbon foams in accordance with the present invention are prepared from polymeric foams, such as polyurethane foams or phenolic foams, with phenolic foams being preferred. Phenolic resins are a large family of polymers and oligomers, composed of a wide variety of structures based on the reaction products of phenols with formaldehyde. Phenolic resins are prepared by the reaction of phenol or substituted phenol with an aldehyde, especially formaldehyde, in the presence of an acidic or basic catalyst. Phenolic resin foam is a cured system composed of open and closed cells. The resins are generally aqueous resols catalyzed by sodium hydroxide at a formaldehyde-to-phenol ratio which can vary, but is preferably about 2:1. Free phenol and formaldehyde content should be low, although urea may be used as a formaldehyde scavenger.

The precursor polymeric foam is prepared by adjusting the water content of the resin and by adding a surfactant (e.g., an ethoxylated nonionic), a blowing agent (e.g., pentane, methylene chloride, or chlorofluorocarbon), and an acid catalyst. The acid catalyst catalyzes the reaction, while the exotherm causes the blowing agent, emulsified in the resin, to evaporate and hence expand the foam. The surfactant controls the cell size as well as the ratio of open-to-closed cell units. Both batch and continuous processes are employed. In the continuous process, the machinery is similar to that used for continuous polyurethane foam. The properties of the foam depend mainly on density and the cell structure.

The preferred acid catalyst for preparing the foam from the resin is phosphoric acid, the more preferred acid catalyst is polyphosphoric acid. Other acids such as toluenesulfonic acid or phenolsulfonic acid can also be used in this part of the process alone or in combination with phosphoric acid.

The preferred phenol is resorcinol; however, other phenols of similar kind that are able to form condensation products with aldehydes can also be used. Such phenols include monohydric and polyhydric phenols, pyrocatechol, hydroquinone, alkyl-substituted phenols, such as, for example, cresols or xylenols, polynuclear monohydric or polyhydric phenols, such as, for example, naphthols, p.p′-dihydroxydiphenyl, dimethyl methane or hydroxyanthracenes.

The phenols used to make the foam precursor material can also be used in admixture with non-phenolic polymeric materials that are able to react with aldehydes in the same way as phenol.

The preferred aldehyde for use in the solution is formaldehyde. Other suitable aldehydes include those which will react with phenols in the same manner. These include, for example, acetaldehyde and benzaldehyde.

In general, the phenols and aldehydes that can be used in the process of the invention are those described in U.S. Pat. Nos. 3,960,761 and 5,047,225, the disclosures of which are incorporated herein by reference.

In order to provide improved oxidation resistance to the inventive foam, the catalyst employed during the initial formation of the resin must be selected for such properties. In other words, to form a polymeric foam, a resin such as a “resol” is first formed by catalysis by a base such as a solution of sodium hydroxide. The base catalyst is significant as it begins the polymerization reactions with the catalyst deprotonating the phenol compounds to phenoxide structures that react the aldehyde, and ultimately lead to the highly linked resol resin end product.

Generally, when carbon foam is made from a sodium hydroxide catalyzed resol, the final foam product contains a high concentration of sodium retained from the processes of producing the resol resin through carbonizing the phenolic foam to carbon foam. Specifically, sodium can be present from 0.1% up to 2% by weight within the structure of the carbon foam. These concentrations of sodium result in a carbon foam product that is highly reactive to air (thus, oxidizing), as sodium is a strong oxidation catalyst for carbon. (P. L. Walker et. al. in CHEMISTRY AND PHYSICS OF CARBON, Vol. 4., 292 (Marcel Dekker eds., 1968).

By the use of a basic polymerization catalyst containing no sodium, the final carbon foam will have an increased oxidation resistance. Optimally, the sodium or other metals in the carbon foam should be about 0%. One method of obtaining a low final concentration of metal is by using an aqueous solution of ammonia as the polymerization base catalyst instead of sodium hydroxide. The ammonia solution will act in a similar manner as sodium hydroxide, deprotonating the phenol compound, thus initiating the formation of the resin. This resin can be treated same as a resin created from sodium hydroxide, but instead results in a phenolic foam with virtually no metal contaminants. The sodium-free foam, then undergoes the identical step of carbonization, creates a carbon foam with an increased strength-to-density ratio as well as increased oxidation resistance.

In another embodiment, a base catalyst comprising an alkaline earth metal hydroxide can be used in place of sodium hydroxide. Specifically this metal hydroxide could be magnesium hydroxide, calcium hydroxide, barium hydroxide or strontium hydroxide. These metal hydroxides function identically to sodium hydroxide, but result in metal cations that are much less effective in promoting carbon oxidation. Thus the final carbon foam product would be incorporated with a metal far less effective in causing oxidation than sodium.

Another approach to increasing the oxidation resistance of carbon foam is by the specific inclusion of compounds solely for improving the oxidation resistance of the carbon foam. Such solid oxidation inhibiting additives include ammonium phosphate, aluminum phosphate, zinc phosphate or boric acid. An additional characteristic of the oxidation inhibiting additives is that the additives can be added during either the resin production stage or the phenolic foam forming stage of carbon foam production. Using either method, the final carbonization of the phenolic foam results in phosphorous or boron retained within the carbon foam structure that reduces the rate of oxidation of the carbon foam. Specifically, phosphorous or boron retained in the final carbon foam product from about 0.01% to about 0.5% by weight reduces the rate of oxidation by over 50%

Finally, the carbon foam product can be treated with an oxidation-inhibiting agent after the completion of the carbonization process. The preferred method would be to impregnate the carbon foam with aqueous solutions of phosphorous-containing materials such as ammonium phosphate, phosphoric acid, aluminum phosphate, or zinc phosphate, or with polyphosphoric acid followed by a heat treatment to above about 300° C. to simultaneously remove the water and fix the phosphorous to the carbon. Additionally, water-soluble boron compounds such as boric acid can be introduced in the above manner to create an oxidation-resistant carbon foam product.

The polymeric foam precursor prepared as described above, which is used as the starting material in the production of the inventive carbon foam, should have an initial density that mirrors the desired final density for the carbon foam to be formed. In other words, the polymeric foam should have a density of about 0.03 to about 0.8 g/cm³, more preferably, about 0.1 to about 0.6 g/cm³. The cell structure of the polymeric foam should be closed with a porosity of between about 50% and about 95% and a relatively high compressive strength, i.e., on the order of at least about 100 psi, and as high as about 300 psi or higher.

In order to convert the polymeric foam to carbon foam, the foam is carbonized by heating to a temperature of from about 500° C., more preferably, at least about 800° C., up to about 3200° C., in an inert or air-excluded atmosphere, such as in the presence of nitrogen. For phosphorous-containing foam, heat treatment can be carried out up to about 1000° C. while retaining the oxidation inhibition due to retained phosphorous. For boron, the oxidation inhibition is maintained for foam heat-treated up to about 3200° C. The heating rate should be controlled such that the polymeric foam is brought to the desired temperature over a period of several days, since the polymeric foam can shrink by as much as about 50% or more during carbonization. Care should be taken to ensure uniform heating of the polymeric foam article for effective carbonization.

By the use of a polymeric foam heated in an inert or air-excluded environment, a non-graphitizable carbon foam is obtained, which has the approximate density of the starting polymeric foam, but a compressive strength of at least about 2000 psi and, significantly, a ratio of strength to density of at least about 7000 psi/(g/cm³), more preferably, at least about 8000 psi/(g/cm³). The carbon foam has a relatively uniform distribution of isotropic cells having, on average, an aspect ratio of between about 1.0 and about 1.5.

The resulting carbon foam has a total porosity of about 50% to about 95%, more preferably, about 60% to about 95% with a bimodal cell size distribution; at least about 90%, more preferably, at least about 95%, of the cell volume is composed of the cells of about 10 to about 150 microns in diameter, more preferably about 15 to about 95 microns in diameter, most preferably about 25 to about 95 microns in diameter, while at least about 1%, more preferably about 2% to about 10%, of the cell volume is composed of the cells of about 0.8 to about 3.5 microns, more preferably about 1 to about 2 microns, in diameter. The bimodal cell-structure nature of the inventive foam provides an intermediate structure between open-cell foams and closed-cell foams, limiting the fluid permeability of the foam while maintaining a foam structure. Nitogen gas permeabilities less than 3.0 darcys, even less than 2.0 darcys, are preferred.

Typically, characteristics such as porosity and individual cell size and shape are measured optically, such as by the use of an optical microscopy using bright field illumination, and are determined using commercially available software, such as Image-Pro Software available from MediaCybernetic of Silver Springs, Md.

In order to further illustrate the principles and operation of the present invention, the following example is provided. However, this example should not be taken as limiting in any regard.

### EXAMPLE 1

A 15 gram sample of carbon foam was obtained with a density of 0.32 g/cm³ and a sodium content of 0.8% by weight. The above foam was carbonized through the following steps. A phenolic foam was packed in a steel can, protected from air and then heated at 2° C. per hour to a temperature of 550° C. and then at 10° C. per hour to 850° C. and held for about 20 hours at that temperature. The resultant carbon foam has a density of 0.32 g/cm³ and a compressive strength of 4200 psi, for a strength-to-density ratio of over 12,500 psi/(g/cm³).

The sample was then placed in a glass vessel and subjected to a vacuum. A solution of about 18% by weight of ammonium dihyrogen phosphate in water was then introduced into the evacuated vessel and the foam sample was held overnight while totally immersed in the solution at atmospheric pressure. The treated foam sample was then dried in a vacuum oven at about 150° C.

The phosphate treated carbon foam was subsequently heat treated in an inert atmosphere to about 850° C. to complete the fixation of phosphorous to the carbon.

The treated sample was then subjected to oxidation testing along with an identical piece of carbon foam which had not been phosphate treated. The oxidation test involves placing about a 1 gram sample of both treated and untreated material into a 1 inch diameter ceramic crucible and then heating the crucible containing the sample in a LECO TGA 601 apparatus in an air atmosphere to a temperature of 593° C. at a rate of about 10° C./minute. Both samples were maintained at the 593° C. while recording the weight loss over a period of up to 24 hours.

After 1 hour in which temperature had been raised from 25° C. to 593° C., the untreated sample had lost 15.4% by weight while the treated sample lost only 3.4% by weight. After holding at 1 hour at 593° C., the untreated sample had lost 51.2% of its weight while the treated sample lost only 26.2%. After 169 minutes at 593° C., the untreated sample lost essentially all of its carbon content while the treated sample still retained about 43% of its original weight.

### EXAMPLE 2

A 2 gram sample of carbon foam was immersed in 85% polyphosphoric acid and held at atmospheric pressure at 80° C. within the acid. The treated sample and a similar untreated sample were then heat treated to 350° C. in an inert atmosphere and subjected to the same oxidation testing as described in Example 1. The untreated sample lost about 35.3% weight after heating from 25° C. to 593° C. in 1 hour while the treated sample lost 20.6% weight. After about 1 hour at 593° C. the untreated sample lost nearly all its weight while the treated sample had lost only 33.9% weight in that 1 hour time period at 593° C.

Accordingly, by the practice of the present invention, carbon foams having heretofore unrecognized characteristics are prepared. These foams exhibit exceptional resistance to oxidation as well as high compressive strength to density ratios and have a distinctive bimodal cell structure, making them uniquely effective in applications, such as composite tooling and thermal insulation.

The disclosures of all cited patents and publications referred to in this application are incorporated herein by reference.

The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention, unless the context specifically indicates the contrary.

What is claimed is:

1. A method for creating a carbon foam material with an improved oxidation-resistance, which comprises the steps of:
a) blending formaldehyde with phenol to form a reactive mixture,
b) polymerizing the reactive mixture with a basic catalyst to form a resin article with a metal content of less than about 0.2% by weight of the resin article,
c) treating the resin article with an acid catalyst, a blowing agent, and a surfactant to convert the resin article into a phenolic foam product,
d) carbonizing the phenolic foam product to create the carbon foam material with an increased oxidation resistance.

2. The method of claim 1, wherein the reactive mixture contains formaldehyde and phenol in proportions of about 1.15 to about 2.5 moles of formaldehyde for each mole of phenol.

3. The method of claim 1 wherein the basic catalyst is a solution of ammonia and water.

4. The method of claim 1 wherein the acid catalyst is selected from the group consisting of phosphoric acid, polyphosphoric acid, p-toluene sulfonic acid, sulfuric acid and combinations thereof.

5. The method of claim 4 wherein the sulfonic acid is an arylsulfonic acid.

6. The method of claim 1 wherein the blowing agent is selected from the group consisting of a fluorocarbon, a hydrocarbon and combinations thereof.

7. The method of claim 6 wherein the hydrocarbon is aliphatic.

8. The method of claim 1 further comprising: mixing a solid oxidation-inhibiting additive with the reactive mixture, to increase the oxidation resistance of the carbon foam material.

9. The method of claim 8 wherein the solid oxidation-inhibiting additive is added during step c).

10. The method of claim 8 wherein the solid oxidation inhibiting additive is selected from the group consisting of ammonium phosphate, aluminum phosphate, zinc phosphate, boric acid and combinations thereof.

11. The method of claim 8 wherein the final concentration of boron in the carbon foam product is from about 0.01% to about 0.5% by weight.

12. The method of claim 8 wherein the final concentration of phosphorous in the carbon foam product is from about 0.01% to about 0.5% by weight.

13. The method of claim 1 further comprising impregnating the carbon foam material with an aqueous solution of oxidation inhibitor and heating the impregnated carbon foam to remove excess water and fix the oxidation inhibitor to the carbon foam material.

14. The method of claim 13 wherein the oxidation inhibitor is selected from the group consisting of ammonium phosphate, aluminum phosphate, zinc phosphate, phosphoric acid, boric acid, and combinations thereof.

15. The method of claim 13 wherein the oxidation inhibitor is polyphosphoric acid.

16. The method of claim 13 wherein the impregnated carbon foam is heated to about 300 degree Celsius or greater.

17. The method of claim 1 wherein the step of carbonizing the phenolic foam product comprises heating the phenolic foam in a non-oxidizing atmosphere to a temperature sufficient to carbonize the phenolic foam to provide the carbon foam material.

18. The method of claim 17 wherein the non-oxidizing atmosphere is applied at a pressure of from about ambient pressure to about 50 psi.

19. The method of claim 17 wherein the temperature is attained using a temperature ramp rate of from about 1 degree Celsius to about 50 degree Celsius per hour.

20. A carbon foam having a density from about 0.03 g/cm³ to about 0.6 g/cm³ and a compressive strength of at least about 2000 psi, wherein the carbon foam has a metal content of less than about 0.1% by weight.

21. The foam of claim 20 that has a porosity of between 50% and about 95%.

22. The foam of claim 21 wherein the cells of the carbon foam have, on average, an aspect ratio of between about 1.0 and about 1.5.

23. The foam of claim 21 wherein at least about 95% of the cell volume of the cells has a diameter of between about 25 and about 95 microns.
